(19) United States
(12) Patent Application Publication
(10) Pub. No.: US 2022/0046579 A1
(43) Pub. Date: Feb. 10, 2022

(54) METHOD AND APPARATUS FOR PROVIDING AND OBTAINING UAV FLIGHT PATH

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 17/278,933

(22) PCT Filed: Sep. 27, 2018
(86) PCT No.: PCT/CN2018/107988

§ 371 Date: Mar. 23, 2021

(51) Int. Cl. H04W 68/00; G08G 5/00; B64C 39/02

(52) U.S. Cl. CPC H04W 68/005; H04W 84/06; B64C 39/024; G08G 5/0013

(57) ABSTRACT

The present disclosure can provide a method and an apparatus for providing and obtaining a UAV flight path. After the access network device obtains the flight path information of the UAV, the access network device can send the paging signaling carrying the flight path information of the UAV to other access network devices, in order to instruct other access network devices to page the UAV and provide the flight path information to the UAV.

### RELATED APPLICATIONS

This application is the US national phase application of International Application No. PCT/CN2018/107988, filed on Sep. 27, 2018, the entire contents of which are incorporated herein by reference.

### TECHNICAL FIELD

The present disclosure relates to a field of communication technology, including to a method, an apparatus and a system for providing and obtaining a UAV flight path.

### BACKGROUND

Unmanned Aerial Vehicle (UAV) have been applied to many fields including vegetation protection, film and television shooting, surveying and mapping, scientific investigation, power inspection, and the like. UAV flight includes two modes. One is a fixed mode, where the UAV flies according to the planned flight path. The other is a dynamic mode, where the UAV flies according to the real-time control of the controller. However, in the fixed mode, it can be difficult for the UAV to obtain the flight route from a UAV management system.

### SUMMARY

According to a first aspect of the disclosure, a method for providing a UAV flight path is provided. The method can include receiving by a first access network device, flight path information of a UAV in an inactive state. The method can further include sending by the first access network device, a paging signaling carrying the flight path information of the UAV to a second access network device. The paging signaling can be configured to instruct the second access network device to page the UAV and provide the flight path information to the UAV.

According to a second aspect of the disclosure, a method for providing a UAV flight path is provided. The method can include receiving by a second access network device, a paging signaling sent by a first access network device, flight path information of a UAV in an inactive state being carried by the paging signaling, and sending by the second access network device, a paging message configured to page the UAV, according to the paging signaling.

According to a third aspect of the disclosure, a method for obtaining a UAV flight path is provided. The method can include receiving by a UAV, a paging message sent by an access network device, wherein the paging message is configured to page the UAV in an inactive state, and, when the paging message includes flight path information of the UAV, obtaining by the UAV, the flight path information from the paging message.

According to a fourth aspect of the disclosure, an apparatus for providing a UAV flight path is provided. The apparatus is applied to a first access network device, and can include a processor and a memory configured to store instructions executable by the processor. Further, the processor to can be configured to receive flight path information of a UAV in an inactive state, and send a paging signaling carrying the flight path information of the UAV to a second access network device, wherein, the paging signaling is configured to instruct the second access network device to page the UAV, and provide the flight path information to the UAV.

According to a fifth aspect of the disclosure, an apparatus for providing a UAV flight path is provided. The apparatus is applied to a second access network device, and can include a processor and a memory configured to store instructions executable by the processor. The processor can be configured to receive a paging signaling sent by a first access network device, flight path information of a UAV in an inactive state being carried by the paging signaling, and send a paging message configured to page the UAV, according to the paging signaling.

According to a sixth aspect of the disclosure, an apparatus for obtaining a UAV flight path is provided. The apparatus is applied to a UAV, and can include a processor and a memory configured to store instructions executable by the processor. The processor can be configured to receive a paging message sent by an access network device, wherein the paging message is configured to page the UAV in an inactive state, and obtain flight path information from the paging message when the paging message includes the flight path information of the UAV.

According to a seventh aspect of the disclosure, a system for providing a UAV flight path is provided. The system includes a first access network device, a second access network device and a UAV. The first access network device includes the apparatus as described in the fourth aspect, the second access network device includes the apparatus as described in the fifth aspect, and the UAV includes the apparatus as described in the sixth aspect, or the first access network device includes the apparatus as described in the seventh aspect, the second access network device includes the apparatus as described in the eighth aspect, and the UAV includes the apparatus as described in the ninth aspect.

According to an eighth aspect of the disclosure, a non-transitory computer readable storage medium is provided. The storage medium is stored thereon with a computer program. When the computer program is executed by a processor, steps of the method described in the first aspect, or steps of the method described in the second aspect, or steps of the method described in the third aspect are implemented.

It should be noted that, the details above and in the following are exemplary and illustrative, and do not constitute the limitation on the present disclosure.

### BRIEF DESCRIPTION OF THE DRAWINGS

The drawings herein are incorporated into the specification and constitute a part of the specification, show exemplary embodiments in conformity with embodiments of the present disclosure, and explain the principle of the present disclosure together with the specification.

FIG. 1 is a schematic diagram illustrating a network architecture according to an exemplary embodiment.

FIG. 2 is a flowchart illustrating a method for providing a UAV flight path according to an exemplary embodiment.

FIG. 3 is a block diagram illustrating an apparatus for providing a UAV flight path according to an exemplary embodiment.

FIG. 4 is a block diagram illustrating an apparatus for providing a UAV flight path according to another exemplary embodiment.

FIG. 5 is a block diagram illustrating an apparatus for obtaining a UAV flight path according to another exemplary embodiment.

FIG. 6 is a block diagram illustrating a structure of an access network device according to an exemplary embodiment.

FIG. 7 is a block diagram illustrating a structure of a UAV according to an exemplary embodiment.

### DETAILED DESCRIPTION

The exemplary embodiments will be described in detail here, and examples thereof are shown in the accompanying drawings. When the following descriptions refer to the accompanying drawings, unless otherwise indicated, the same numbers in different drawings represent the same or similar elements. The implementations described in the following exemplary embodiments do not represent all the implementations consistent with the present disclosure. Rather, they are merely examples of the apparatus and method consistent with some aspects of the present disclosure as detailed in the appended claims.

The network architecture and business scenario described in embodiments of the present disclosure are intended to explain the technical solutions of embodiments of the present disclosure more clearly, and does not constitute a limitation to the technical solutions provided by embodiments of the present disclosure. It should be understood that, with the evolution of network architecture and the emergence of new business scenarios, the technical solutions provided in the exemplary embodiments of the present disclosure can also be applied to similar technical issues.

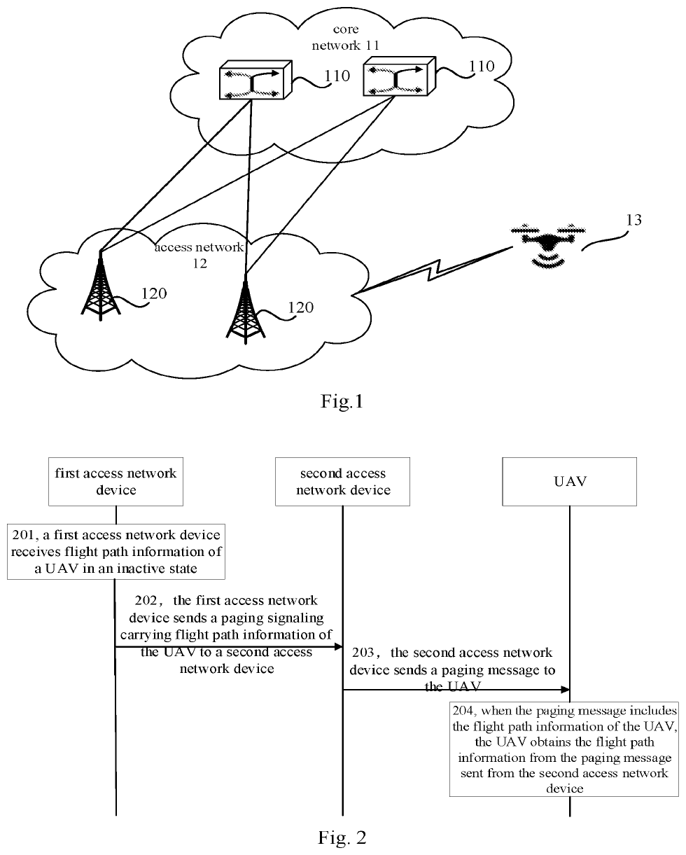

FIG. 1 is a schematic diagram illustrating a network architecture according to an exemplary embodiment. The network architecture may include a core network 11, an access network 12, and a UAV 13.

The core network 11 includes several core network devices 110. The main function of the core network device 110 is to provide user connection, provide user management and complete services carrying, providing an interface to an external network as a hosted network. For example, in the core network of LTE (Long Term Evolution) system, it may include MME (Mobility Management Entity), S-GW (Serving Gateway), and P-GW (PDN Gateway). In the core network of 5G NR (New Radio) system, it may include AMF (Access and Mobility Management Function) entity, UPF (User Plane Function) entity and SMF (Session Management Function) entity.

The access network 12 includes several access network devices 120. The access network device 120 and the core network device 110 communicate with each other through some kind of air interface technology, for example, S1 interface in the LTE system, NG interface in the 5G NR system. The access network device 120 may be a base station (BS). The base station is an apparatus deployed in the access network to provide wireless communication function for terminals. The base station may include various forms of macro base stations, micro base stations, relay stations, access points, etc. In the system adopting different wireless access technologies, the name of the device with base station function may vary. For example, in LTE system, it is called eNodeB or eNB. In 5G NR system, it is called gNodeB or gNB. With the evolution of communication technology, the name of “base station” may vary. For convenience of description, in embodiments of the present disclosure, the above apparatus that provide wireless communication function for terminals are collectively referred to as access network devices.

The access network device 120 is configured to provide services for the UAV 13. Wireless connection may be established between the UAV 13 and the access network device 120. For example, the UAV 13 and the access network device 120 communicates with each other through some kind of air interface technology, such as cellular technology. The access network device 120 may control the UAV 13 through the above wireless connection, and the UAV 13 may run under the control of the access network device 120.

Optionally, the access network device 120 is further configured to provide services for the terminal in addition to providing service for the UAV 13. The terminals may include various handheld devices, vehicle-mounted devices, wearable devices, computing devices with wireless communication function or other processing devices connected to wireless modems, as well as various forms of user equipment (UE), mobile stations (MS), terminal devices, and the like. For convenience of description, the devices mentioned above are collectively called terminals.

UAV is short for Unmanned Aerial Vehicle, and is an unmanned aircraft operated by radio remote control equipment and self-prepared program control apparatus. UAV is actually a general term for unmanned aircrafts, which may include unmanned fixed-wing aircrafts, unmanned vertical take-off and landing aircrafts, unmanned airships, unmanned helicopters, unmanned multi-rotor aircrafts, unmanned para-wing aircrafts, and the like.

The UAV 13 has been widely used in aerial photography, agriculture, plant protection, micro selfies, express transportation, disaster rescue, observation of wild animals, monitoring of infectious diseases, surveying and mapping, news reporting, power inspection, disaster relief, film and television shooting, romantic creation, and the like. In order to further expand the application scope of UAV 13, relevant international standards organizations have also established a project to study and standardize how the cellular network may provide the UAV 13 with services that meet the requirements.

Of course, the technical solutions described in embodiments of the present disclosure may apply to LTE system as well as subsequent evolution of the LTE system, for example, LTE-A (LTE-Advanced) system or 5G NR system.

FIG. 2 is a flowchart illustrating a method for providing a UAV flight path according to an exemplary embodiment. The method may be applied to the network structure as shown in FIG. 1. The method may include several blocks as follows.

At block 201, a first access network device receives flight path information of a UAV in an inactive state. In embodiments of the present disclosure, for the UAV in the inactive state, a technical solution that flight path information is quickly provided by an access network device is provided.

The first access network device may receive the flight path information of the UAV from a UAV management system, and also may receive the flight path information of the UAV from a core network device. In embodiments of the present disclosure, the flight path information of the UAV may include the flight path of the UAV. For example, the flight path of the UAV may be the flight path planned for the UAV by the UAV management system, and also may be the flight path planned for the UAV by the core network device.

Optionally, the above core network device is a mobile management network element in the core network. The mobile management network element is a functional network element in charge of access authentication and mobility management. For example, in LTE system, the mobile management network element may be an MME; in 5G NR system, the mobile management network element may be an AMF entity.

In addition, RRC (Radio Resource Control) connection may be established between the access network device and the UAV, and the signaling and/or data may be transmitted through the RRC connection. Optionally, based on the state of RRC connection, the state of the UAV may include: idle state, connected state, and inactive state. Idle state means that RRC connection has not been established between the UAV and the access network device. Connected state means that RRC connection has been established between the UAV and the access network device, and the RRC connection is in the active state. Inactive state means that RRC connection has been established between the UAV and the access network device, but the RRC connection is in the inactive state. When the UAV is in the inactive state, since the access network device cannot send the flight path information to the UAV through RRC message, the access network device pages the UAV through RAN-initiated paging.

At block 202, the first access network device sends a paging signaling carrying the flight path information of the UAV to a second access network device. The paging signaling is configured to instruct the second access network device to page the UAV, and provide the flight path information to the UAV.

The first access network device may send the paging signaling to the access network devices (for example, including the second access network device) in the wireless notification area where the UAV is located, so as to instruct the access network device receiving the paging signaling to page the UAV. The above paging signaling may include the flight path information of the UAV. One wireless notification area may include a cell coverage area covered by one or more access network devices.

Optionally, the interaction of the above paging signaling is through the communication interface signaling between the access network devices. For example, in 5G NR system, the above communication interface is Xn interface, and the first access network device sends the paging signaling to the second access network device through RAN PAGING signaling of Xn interface.

Optionally, the above paging signaling may further include identification information of the UAV in addition to the flight path information of the UAV. The identification information of the UAV is configured to uniquely indicate the UAV, and different UAVs have different identification information.

After receiving the paging signaling configured to instruct it to page the UAV, the second access network device may page the UAV through RAN-initiated paging, and provide the flight path information to the UAV. In addition, the first access network device may page the UAV by itself through RAN-initiated paging after obtaining the flight path information of the UAV.

At block 203, the second access network device sends a paging message to the UAV. When the UAV is in the cell coverage area covered by the second access network device, the UAV may receive the paging message sent by the second access network device. The paging message is configured to page the UAV in the inactive state. Optionally, the above paging message includes the identification information of the UAV. The above paging message can further include the flight path information of the UAV, so that the UAV may obtain the flight path information quickly.

At block 204, when the paging message includes the flight path information of the UAV, the UAV obtains the flight path information from the paging message sent by the second access network device. After receiving the paging message, the UAV may judge if the paging message received aims at itself according to identification message of the UAV carried by the paging message. If the UAV determines the paging aims at itself, and the paging message includes the flight path information of the UAV, the UAV obtains the flight path information from the paging message received. When the paging message does not include flight path information, after establishing connection with the UAV, the second access network device sends the flight path information of the UAV to the UAV through the connection.

The above connection may be RRC connection. When the UAV is in the inactive state, the UAV needs to restore the established RRC connection first when needing to interact with the access network device, and then interacts with the access network device through the RRC connection.

If the UAV determines the paging aims at itself, the UAV sends RRCConnectionResumeRequest to the second access network device. RRCConnectionResumeRequest is configured to request to restore RRC connection with the second access network device. After the UAV restores RRC connection with the second access network device, the second access network device may send RRC message to the UAV through the RRC connection. The RRC message carries the flight path information of the UAV. Optionally, if the UAV determines the paging does not aim at itself, it is not necessary to send RRCConnectionResumeRequest to the second access network device, and the UAV may keep the inactive state.

In addition, when the UAV is in the cell coverage area covered by the first access network device, the UAV may directly receive the paging message sent by the first access network device. The above paging message may or may not carry the flight path information of the UAV. When the paging message carries the flight path information of the UAV, the UAV directly obtains the flight path information from the paging message received. When the paging message does not carry the flight path information of the UAV, the UAV may first establish connection with the first access network device, and then obtain the flight path information from the first access network device through this connection.

In conclusion, in the technical solutions provided in embodiments of the present disclosure, for the UAV in the inactive state, after the access network device obtains the flight path information of the UAV, the access network device sends the paging signaling carrying the flight path information of the UAV to other access network devices, to instruct other access network devices to page the UAV and provide the flight path information to the UAV, which achieves issuing of flight path information of the UAV, so that the UAV can obtain the flight path information.

In addition, the paging message sent by the access network device to the UAV includes the flight path information of the UAV, so that the UAV may obtain the flight path information directly from the paging message, which realizes that the access network device provides the flight path information for the UAV quickly.

It should be noted that, in the above method embodiments, the technical solution of the present disclosure is introduced only from the perspective of the interaction between the access network device and the UAV. The above blocks related to the first access network device may be separately implemented as a method for providing a UAV flight path on the first access network device side. The above blocks related to the second access network device may be implemented separately as a method for providing a UAV flight path on the second access network device side. The above blocks related to the UAV may be separately implemented as a method for obtaining a UAV flight path on the UAV side.

The below are apparatus embodiments of the present disclosure, which may be configured to implement the method embodiments of the present disclosure. For details not disclosed in the apparatus embodiments of the present disclosure, please refer to the method embodiments of the present disclosure.

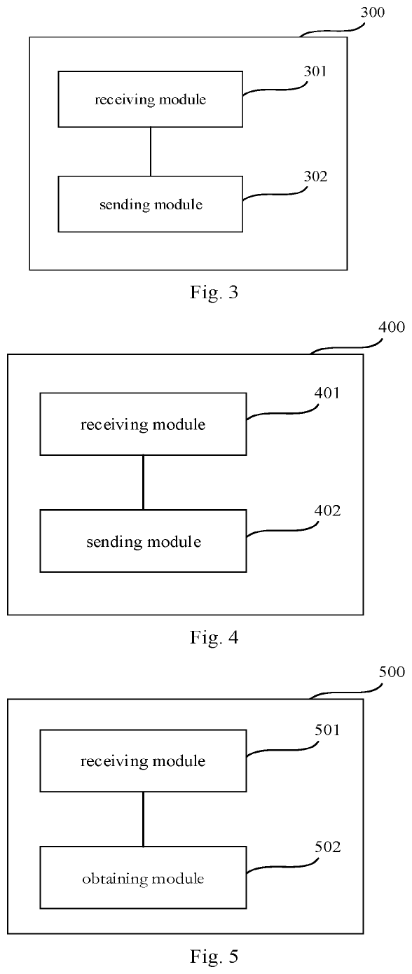

FIG. 3 is a block diagram illustrating an apparatus for providing a UAV flight path according to an exemplary embodiment. The apparatus has the function of implementing the above method example of the first access network device side. The function may be implemented by hardware, or by hardware to execute the corresponding software. The apparatus may be the first access network device introduced above, or may be configured in the first access network device. The apparatus 300 may include a receiving module 301 and a sending module 302. Of course, it should be understood that one or more of the modules described in this specification can be implemented by hardware, such as circuitry.

The receiving module 301 is configured to receive flight path information of the UAV in the inactive state. The sending module 302 is configured to send a paging signaling carrying the flight path information of the UAV to a second access network device. The paging signaling is configured to instruct the second access network device to page the UAV, and provide the flight path information to the UAV.

In conclusion, in the technical solution provided in embodiments of the present disclosure, for the UAV in the inactive state, after the access network device obtains flight path information of the UAV, the access network device sends the paging signaling carrying the flight path information of the UAV to other access network devices, to instruct other access network devices to page the UAV and provide flight path information for the UAV, which achieves issuing of flight path information of the UAV, so that the UAV can obtain the flight path information.

In an optional embodiment provided based on embodiments of FIG. 3, the receiving module 301 is configured to receive the flight path information of the UAV from a UAV management system, or receive the flight path information of the UAV from a core network device. In another optional embodiment provided based on embodiments of FIG. 3 or any of the above optional embodiments, the sending module 302 is configured to send the paging signaling to the second access network device in a RAN Notification Area where the UAV is located.

In another optional embodiment provided based on embodiments of FIG. 3 or any of the above optional embodiments, the sending module 302 is further configured to send a paging message configured to page the UAV. The paging message can include the flight path information of the UAV.

Optionally, the sending module 302 is further configured to send the flight path information of the UAV to the UAV through connection after establishing the connection with the UAV.

FIG. 4 is a block diagram illustrating an apparatus for providing the UAV flight path according to another example embodiment. The apparatus has the function of implementing the above method example of the second access network device side. The function may be implemented by hardware, or by hardware to execute the corresponding software. The apparatus may be the second access network device described above, or also may be configured in the second access network device. The apparatus 400 may include a receiving module 401 and a sending module 402.

The receiving module 401 is configured to receive a paging signaling sent by a first access network device. Flight path information of the UAV in the inactive state is carried by the paging signaling.

The sending module 402 is configured to send a paging message configured to page the UAV, according to the paging signaling.

In conclusion, in the technical solution provided in embodiments of the present disclosure, for the UAV in the inactive state, after the access network device obtains the flight path information of the UAV, the access network device sends the paging signaling carrying the flight path information of the UAV to other access network devices, to instruct other access network devices to page the UAV and provide the flight path information for the UAV, which achieves issuing of flight path information of the UAV, so that the UAV can obtain the flight path information.

In an optional embodiment provided based on embodiments of FIG. 4, the paging message includes the flight path information of the UAV. In another optional embodiment provided based on embodiments of FIG. 4 or any of the above optional embodiments, the sending module 402 is further configured to send the flight path information of the UAV to the UAV through connection after establishing the connection with the UAV.

FIG. 5 is a block diagram illustrating an apparatus for obtaining the UAV flight path according to another example embodiment. The apparatus has the function of implementing the above method example of the UAV side. The function may be achieved by hardware, or by hardware to execute the corresponding software. The apparatus may be the UAV introduced above, or may be configured in the UAV. The apparatus 500 may include a receiving module 501 and an obtaining module 502.

The receiving module 501 is configured to receive a paging message sent by an access network device, in which the paging message is configured to page the UAV in the inactive state. The obtaining module 502 is configured to obtain flight path information from the paging message when the paging message includes the flight path information of the UAV.

In conclusion, in the technical solution provided in embodiments of the present disclosure, for the UAV in the inactive state, after the access network device obtains the flight path information of the UAV, the access network device sends the paging signaling carrying the flight path information of the UAV to other access network devices, to instruct other access network devices to page the UAV and provide flight path information for the UAV, which achieves issuing of flight path information of the UAV, so that the UAV can obtain the flight path information.

In an optional embodiment provided based on embodiments of FIG. 5, the receiving module 401 is configured to, when the paging message does not include the flight path information, receive the flight path information sent by the access network device through connection after the UAV establishes the connection with the access network device.

It should be noted that, when the apparatus provided in the above embodiments implement its function, the division of the above function modules is only given as an example. In practical applications, the above functional allocation may be completed by different function modules according to actual requirements, that is, the content structure of the device is divided into different function modules to complete all or part of functions described above.

With regard to the apparatus in the above embodiments, the specific way in which each module performs the operation has been described in detail in the embodiments of the method and will not be elaborated here.

An exemplary embodiment of the present disclosure further provides an apparatus for providing a UAV flight path, which may implement the method for providing a UAV flight path provided in the present disclosure. The apparatus may be applied to the first access network device introduced above, or may be configured in the first access network device. The apparatus may include a processor and a memory configured to store instructions executable by the processor. The processor is configured to receive flight path information of a UAV in an inactive state, and send a paging signal carrying the flight path information of the UAV to a second access network device, in which the paging signaling is configured to instruct the second access network device to page the UAV, and provide the flight path information to the UAV.

Optionally, the processor is further configured to receive the flight path information of the UAV from a UAV management system, or receive the flight path information of the UAV from a core network device. The processor can be further configured to send the paging signaling to the second access network device in a RNA where the UAV is located.

Optionally, the processor is further configured to send a paging message configured to page the UAV. The paging message includes the flight path information of the UAV. Further, the processor can be further configured to send the flight path information of the UAV to the UAV through connection after establishing the connection with the UAV.

An exemplary embodiment of the present disclosure further provides an apparatus for providing a UAV flight path, which may implement the method for providing a UAV flight path provided in the present disclosure. The apparatus may be applied to the second access network device introduced above, or may be configured in the second access network device. The apparatus may include a processor and a memory configured to store instructions executable by the processor. The processor is configured to receive a paging signaling sent by the first access network device, flight path information of a UAV in an inactive state being carried by the paging signaling, and send a paging message configured to page the UAV, according to the paging signaling. Optionally, the paging message includes the flight path information of the UAV.

The processor can be further configured to send the flight path information of the UAV to the UAV through connection after establishing the connection with the UAV.

An exemplary embodiment of the present disclosure further provides an apparatus for obtaining a UAV flight path, which may implement the method for obtaining a UAV flight path provided in the present disclosure. The apparatus may be applied to the UAV introduced above, or also may be configured in the UAV. The apparatus may include a processor and a memory configured to store instructions executable by the processor. The processor is configured to receive a paging message sent by an access network device, wherein the paging message is configured to page the UAV in the inactive state, and obtain flight path information from the paging message when the paging message includes the flight path information of the UAV.

Optionally, the processor is further configured to, when the paging message does not include the flight path information, receive the flight path information sent by the access network device through connection after the UAV establishes the connection with the access network device.

A system for providing a UAV flight path is further provided in an exemplary embodiment of the disclosure. The system includes a first access network device, a second access network device and a UAV.

In the above description, the technical solution provided in embodiments of the present disclosure is introduced mainly from the perspective of access network device and UAV. It should be understood that, in order to implement the above functions, the access network device and the UAV include hardware structures and/or software modules that execute various functions. In combination with the units and algorithm steps of the examples described in embodiments of the present disclosure, the embodiments of the present disclosure may be implemented in the form of hardware or a combination of hardware and computer software. Whether a function is executed by hardware or computer software driven by hardware depends on the specific application and design constraints of the technical solution. Those skilled in the art may adopt different methods for each specific application to implement the described functions, but such implementation should not be considered as beyond the scope of the technical solutions of embodiments of the present disclosure.

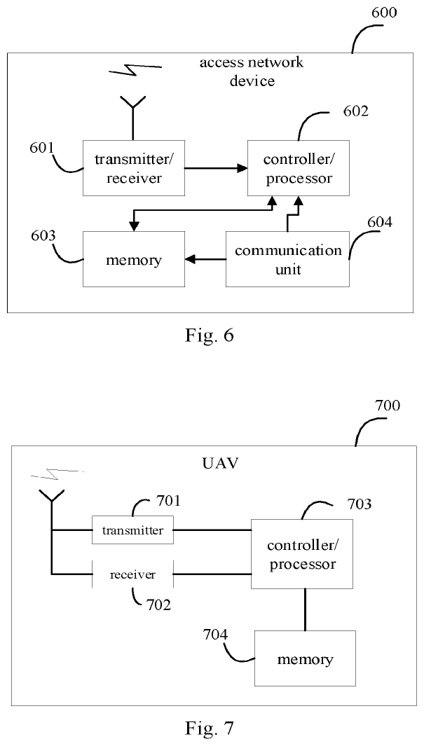

FIG. 6 is a schematic diagram illustrating a structure of an access network device according to an example embodiment. The access network device 600 includes a transmitter/receiver 601 and a processor 602. The processor 602 also may be a controller, represented as a “controller/processor 602” in FIG. 6. The transmitter/receiver 601 is configured to support information transmitting and receiving between the access network device and the terminal in the above embodiments, as well as the communication between the access network device and other network entities. The processor 602 implements various functions for communicating with the terminal. In the uplink, an uplink signal from the terminal is received via an antenna, demodulated by the receiver 601 (for example, a high-frequency signal is demodulated into a baseband signal), and further processed by the processor 602 to restore the service data and signaling information sent by the terminal. In the downlink, the service data and signaling messages are processed by the processor 602, modulated by the transmitter 601 (for example, a baseband signal is modulated into a high-frequency signal) to generate a downlink signal, and transmitted to the terminal via an antenna. It should be noted that, the above demodulation or modulation functions also may be completed by the processor 602. For example, the processor 602 is further configured to execute various blocks on the access network device side (such as the first access network device and the second access network device) in the above method embodiments, and/or other blocks of the technical solutions described in embodiments of the present disclosure.

Further, the access network device 600 may further include a memory 603 configured to store program codes and data of the access network device 600. In addition, the access network device may further include a communication unit 604. The communication unit 604 is configured to support communication between the access network device and other network entities (for example, network devices in the core network, and the like.) For example, in LTE system, the communication unit 604 may be an S1-U interface, configured to support communication between the access network device and S-GW. Alternatively, the communication unit 604 may further be an S1-MME interface, configured to support communication between the access network device and MME; in 5G NR system, the communication unit 604 may be an NG-U interface, configured to support communication between the access network device and UPF entities. Alternatively, the communication unit 604 may be an NG-C interface, configured to support access to AMF entities for communication.

It should be understood that, FIG. 6 only illustrates a simplified design of the access network device 600. In practical applications, the access network device 600 may include any number of transmitters, receivers, processors, controllers, memories, communication units, and the like, and all access network devices that may be implemented in embodiments of the present disclosure are within the protection scope of embodiments of the present disclosure.

FIG. 7 is a structure diagram illustrating a UAV according to an example embodiment. The UAV 700 includes a transmitter 701, a receiver 702 and a processor 703. The processor 703 may also be a controller, represented as a “controller/processor 703” in FIG. 7.

The processor 703 controls and manages actions of the UAV 700, and is configured to execute the processing procedure performed by the UAV 700 in the above embodiments of the present disclosure. For example, the processor 703 is configured to execute various blocks on the UAV side in the above method embodiments, and/or other blocks of the technical solutions described in embodiments of the present disclosure. Further, the UAV 700 may further include a memory 704 configured to store program codes and data of the UAV 700.

It should be understood that, FIG. 7 only illustrates a simplified design of the UAV 700. In practical applications, the UAV 700 may include any number of transmitters, receivers, processors, controllers, memories, and the like, and all UAVs that may be implemented in embodiments of the present disclosure are within the protection scope of embodiments of the present disclosure.

A non-transitory computer readable storage medium with a computer program stored thereon is further provided in embodiments of the present disclosure. The computer program is executed by the processor of the first access network device to implement blocks of the above methods for providing the UAV flight path.

A non-transitory computer readable storage medium with a computer program stored thereon is further provided in embodiments of the present disclosure. The computer program is executed by the processor of the second access network device to implement blocks of the above methods for providing the UAV flight path.

A non-transitory computer readable storage medium with a computer program stored thereon is further provided. The computer program implements blocks of the methods for obtaining UAV flight path when executed by a processor.

It should be understood that, the word “more” mentioned in the text refers to two or more. The word “and/or” describes the relationship of association objects, indicating that there may exist three relationships. For example, A and/or B may represent any of existing A only, existing both A and B, or existing B only. The character “/” generally means the contextual object is a kind of “or” relationship.

After considering the specification and practicing the disclosure herein, those skilled in the art will easily think of other implementations. The present application is intended to cover any variations, usages, or adaptive changes of the present disclosure. These variations, usages, or adaptive changes follow the general principles of the present disclosure and include common knowledge or conventional technical means in the technical field not disclosed by the present disclosure. The description and the embodiments are to be regarded as exemplary only, and the true scope and spirit of the present disclosure are given by the appended claims.

It should be understood that, the present disclosure is not limited to the precise structure described above and shown in the drawings, and various modifications and changes may be made without departing from its scope. The scope of the present application is only limited by the appended claims.

1. A method for providing a UAV flight path, comprising:
receiving, by a first access network device, flight path information of a UAV in an inactive state; and
sending, by the first access network device, a paging signaling carrying the flight path information of the UAV to a second access network device, the paging signaling being configured to instruct the second access network device to page the UAV and provide the flight path information to the UAV.

2. The method of claim 1, wherein 1, receiving the flight path information of the UAV in the inactive state, further comprises
receiving the flight path information of the UAV from:
a UAV management system, or
a core network device.

3. The method of claim 1, wherein sending the paging signaling carrying the flight path information of the UAV to the second access network device, further comprises:
sending the paging signaling to the second access network device in a RAN Notification Area (RNA) where the UAV is located.

4. The method of claim 1, further comprising:
sending, by the first access network device, a paging message configured to page the UAV.

5. The method of claim 4, wherein the paging message comprises the flight path information of the UAV.

6. The method of claim 4, further comprising:
sending, by the first access network device, the flight path information of the UAV to the UAV through a connection after establishing the connection with the UAV.

7. A method for providing a UAV flight path, comprising:
receiving, by a second access network device, a paging signaling carrying flight path information that is sent by a first access network device while a UAV in an inactive state; and
sending, by the second access network device, a paging message configured to page the UAV, based on the paging signaling.

8. The method of claim 7, wherein the paging message comprises the flight path information of the UAV.

9. The method of claim 7, further comprising:
sending, by the second access network device, the flight path information of the UAV to the UAV through the connection after establishing connection with the UAV.

10. A method for obtaining a UAV flight path, comprising:
receiving, by a UAV, a paging message sent by an access network device, the paging message being configured to page the UAV in an inactive state; and
obtaining, by the UAV, flight path information from the paging message when the paging message includes the flight path information of the UAV.

11. The method of claim 10, further comprising:
receiving, by the UAV, the flight path information sent by an access network device through a connection when the paging message does not include the flight path information and after establishing the connection with the access network device.

12-22. (canceled)

23. An apparatus for providing a UAV flight path that is applied to a first access network device, comprising:
a processor; and
a memory that is configured to store instructions executable by the processor,
wherein the processor is configured to perform the method of claim 1.

24. An apparatus for providing a UAV flight path that is applied to a second access network device, comprising:
a processor; and
a memory that is configured to store instructions executable by the processor,
wherein the processor is configured to perform the method of claim 7.

25. An apparatus for obtaining a UAV flight path that is applied to a UAV, comprising:
a processor; and
a memory that is configured to store instructions executable by the processor, wherein the processor is configured to perform the method of claim 10.

26-27. (canceled)
